(19) United States
(12) Patent Application Publication
(10) Pub. No.: US 2020/0122977 A1
(43) Pub. Date: Apr. 23, 2020

(54) ELEVATOR DOOR SYSTEM WITH LATERALLY INSTALLED DOOR KNIFE

(71) Applicant: SUNWA ELEVATOR CO., LTD., XUZHOU (CN)

(72) Inventors: Shuxin DU, XUZHOU (CN); Yonggang XU, XUZHOU (CN); Ai LI, XUZHOU (CN)

(73) Assignee: SUNWA ELEVATOR CO., LTD.

(21) Appl. No.: 16/166,161

(22) Filed: Oct. 22, 2018

(51) Int. Cl. B66B 13/12; B66B 13/08; B66B 13/30

(52) U.S. Cl. CPC B66B 13/12; B66B 13/30; B66B 13/301; B66B 13/08

(57) ABSTRACT

An elevator door system comprises a laterally installed door knife located on a car door hanging plate, door lock wheels located on a landing door hanging plate, a fixing plate disposed in a middle of the car door hanging plate. The fixing plate is connected to a transmission belt, so that door hanging plates can be driven to move. A position-limit plate is disposed above the door knife, and the door knife is controlled by the position-limit plate to clamp door lock wheels. At the same time, the door lock wheels are connected to and open a door hanger via a bar. In order to take advantage of the room saved by laterally moving of the door knife, an addition sill and a brush whose lengths are fit for the door opening area are disposed on a car door sill to fill the space when door is opened.

### TECHNICAL FIELD

The present disclosure relates to a major mechanism of an elevator, and particularly to an elevator door system with a laterally installed door knife.

### BACKGROUND OF THE PRESENT INVENTION

In the prior art, the elevator door knife is fixed on a car door hanging plate of one of car doors in elevator and is located in a middle of a door opening area; and door lock wheels are opposite to the door knife and fixed on a landing door hanging plate above a landing door. When the elevator is running, the door knife clamps the door lock wheels, along with a driver of a car door drive motor, the car doors and the landing doors are opened together. In this way, the door knife and door lock wheels have to beyond the sill in door opening area, and in order to avoid collision between the car and the sill, a necessary gap for moving has to be added when the car moves up and down. Namely, there must be a certain distance between a car door sill and a landing door sill. However, the existence of this distance often leads to some undesirable accidents like that small cart, wheelchair wheel, high-heeled shoes, etc. are stuck, and that keys and bank cards are dropped into the elevator shaft through this gap. In order to solve this problem, the movable sill is applied in the market. A flap opens to fill the gap when the door is open, and the flap is retracted when the door is closed, which does not affect the up and down movement of the elevator car. However, this method will increase the mechanical and electrical structures, and hence increases fault points. If the flap fails to retract in time when the elevator car is moving, it is prone to have rub accidents, so hidden dangers exist.

### SUMMARY OF PRESENT INVENTION

In order to solve the problem above, the present disclosure provides an elevator door system with a laterally installed door knife. By adopting an additional sill in the present disclosure, the gap between a car door sill and a landing door sill in the door opening area will be efficiently decreased. Moreover, the additional sill is stationary, so the retracted movement of the additional sill is not needed when car moves up and down, and the situation that the sill isn't retracted in time won't happen. The security of taking the elevator is improved, hidden dangers are lowered, and the out-looking of the door opening area is more beautiful. The technical solution of the present disclosure is convenient for implementation, the cost is saved and the deficiencies existing in prior art are overcame effectively.

In order to achieve above objects, the technical solution in present disclosure is realized as follows:

An elevator door system with a laterally installed door knife, comprises: a car door head; a landing door head; and a car door, a landing door and a sill structure which are fixed below the car door head and the landing door head.

The car door head comprises a car door main plate, a car door drive motor, a transmission belt, a transmission wheel, a car door hanging plate rail, a car door hanging plate and a door knife system. The car door drive motor and the transmission wheel are fixed on the car door main plate. The transmission belt twists around the car door drive motor and the transmission wheel. The car door hanging plate rail is fixed on the car door main plate, and the car door hanging plate can move along the car door hanging plate rail. The door knife system fixed on the car door hanging plate, comprises a fixing plate fixed on a location near an inside of the car door hanging plate, a substrate plate fixed outside the car door hanging plate, a driven door knife fixed on the substrate plate, a driving door knife connected to the driven door knife, a spring for connecting the substrate plate and the driving door knife, a connecting plate fixed on the substrate plate, a connecting rob for connecting the driving door knife and the connecting plate, a wheel located on an end of the connecting rob near the connecting plate, and a position-limit plate located above the wheel.

The landing door head comprises a landing door main plate, a landing door hanging plate rail fixed on the landing door main plate, a landing door hanging plate that can move along the landing door hanging plate rail, a stationary hanger fixed on the landing door main plate, a movable hanger fixed on a side of the landing door hanging plate through a bearing, door lock wheels fixed outside the landing door hanging plate that the movable hanger located on, and the door lock wheels are connected to the movable hanger through a bar.

The sill comprises a car door sill, a landing door sill and an additional sill, etc. The car door sill is located below the car door. The landing door sill is located below the landing door. The additional sill is fixed on the car door sill and is located in the door opening area. A length of the additional sill is equal to a width of the door opening area, and a width of the additional sill is slightly smaller than a gap between the car door sill and the landing door sill. A brush is fixed on a side of the additional sill near the landing door sill, and a length of the brush is 3-5 mm to fill the gap between the additional sill and the landing door sill.

The beneficial effects by adopting the technical solution above are as follows:

The elevator door system with a laterally installed door knife efficiently decreases the gap between the car door sill and the landing door sill in the door opening area. There is no need for the sill to retract when the elevator car moves up and down, so that the rub accidents will not increase. The security of taking the elevator is improved, hidden dangers are lowered, and the cost of the technical solution is saved and implementation of the technical solution is more convenient.

### DESCRIPTION OF THE DRAWINGS

FIG. 1 is a top plan view of an elevator door system according to the present disclosure;

FIG. 2 is a structural diagram of a car door system according to the present disclosure;

FIG. 3 is an enlarged structural diagram of portion A shown in FIG. 2 according to the present disclosure;

FIG. 4 is a structural diagram of a landing door system according to the present disclosure; and

FIG. 5 is a top plan view of a sill system according to the present disclosure.

### DETAILED DESCRIPTION OF PREFERRED EMBODIMENTS

The present disclosure will now be further described with reference to the accompanying drawings and embodiments.

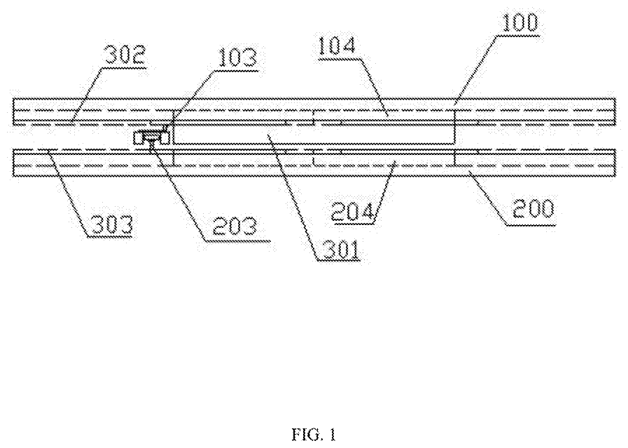

Referring to FIG. 1, the disclosure relates to an elevator door system with a laterally installed door knife, which comprises a car door head 100, a door knife system 103 fixed on a side of the car door head 100 near the door opening area, a landing door head 200, door lock wheels 203 fixed on the landing door head 200 and opposite to a door knife 103, a car door 104 fixed below the car door head 100, a landing door 204 fixed below the landing door head 200, a car door sill 302 below the car door 104, a landing door sill 303 below the landing door 204, and an additional sill 301 fixed on the car door sill 302.

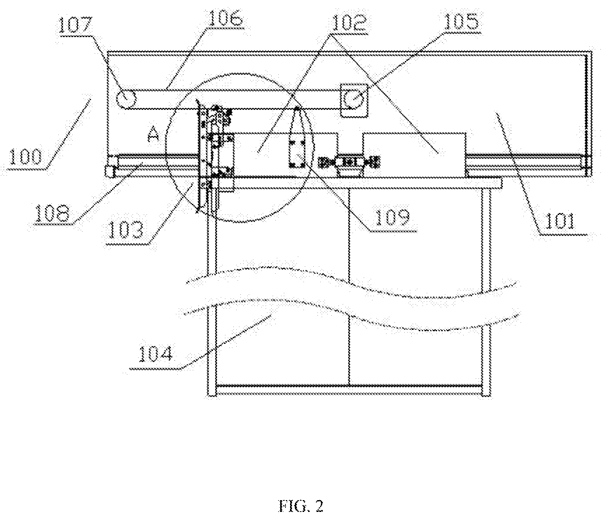

Referring to FIG. 2, the car door head 100 comprises a car door main plate 101, a car door hanging plate 102, the door knife system 103, a car door drive motor 105, a transmission belt 106, a transmission wheel 107, a car door hanging plate rail 108 and a fixing plate 109. The car door drive motor 105 and the transmission wheel 107 are fixed on the car door main plate 101. The transmission belt 106 twists around the car door drive motor 105 and the transmission wheel 107. The car door hanging plate rail 108 is fixed on the car door main plate 101, and the car door hanging plate 102 can move along the car door hanging plate rail 108. The door knife system 103 is fixed on a side of the car door hanging plate 102. The fixing plate 109 is fixed on a middle of the car door hanging plate, and a top of the fixing plate is clamped on the transmission belt 106, so that the fixing plate 109 can move along with the transmission belt.

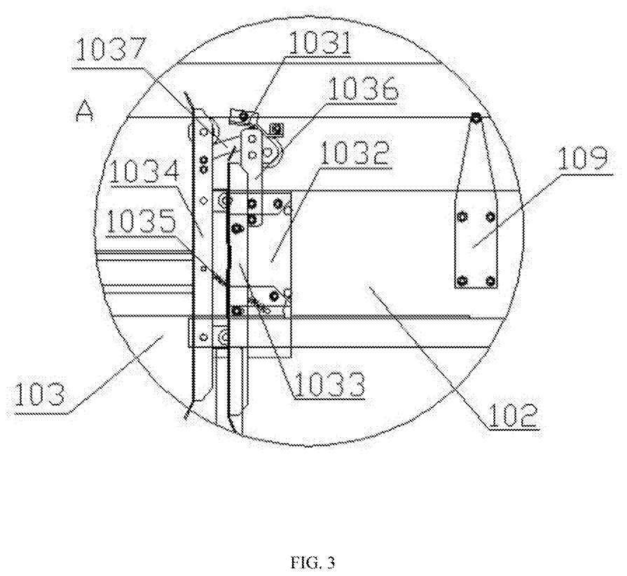

Referring to FIG. 3, the door knife system 103 comprises a substrate plate 1032 fixed outside the car door hanging plate 102, a driven door knife 1033 fixed on the substrate plate 1032, a driving door knife 1034 connected to the driven door knife, a spring 1035 for connecting the substrate plate 1032 and the driving door knife 1034, a connecting plate 1036 fixed on the substrate plate 1032, a connecting rod 1037 for connecting the driving door knife 1034 and the connecting plate 1036, a wheel located on an end of the connecting rod 1037 near the connecting plate 1036, and a position-limit plate 1031 located above the wheel.

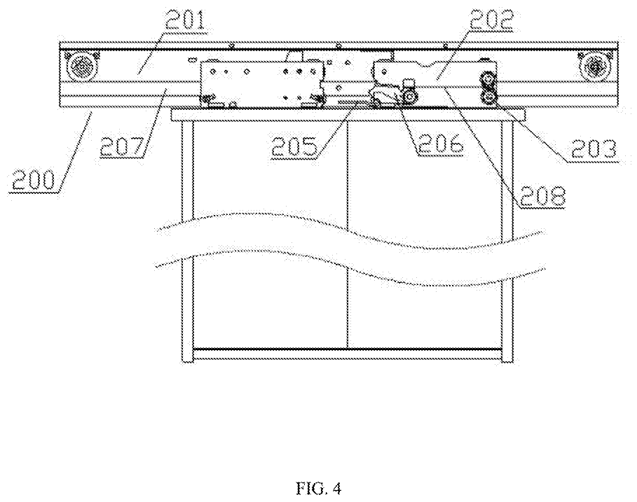

Referring to FIG. 4, the landing door head 200 comprises a landing door main plate 201, a landing door hanging plate rail 207 fixed on the landing door main plate 201, a landing door hanging plate 202 that can move along the landing door hanging plate rail 207, a stationary hanger 205 fixed on the landing door main plate 201, a movable hanger 206 fixed on a side of the landing door hanging plate through a bearing, door lock wheels 203 fixed outside the landing door hanging plate that the movable hanger located on, and these door lock wheels 203 are connected with the movable hanger 206 through a bar 208.

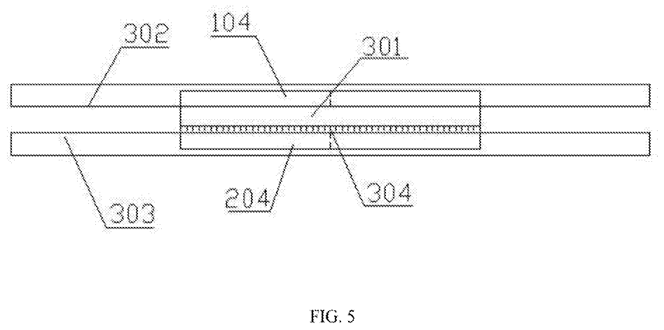

Referring to FIG. 5, the additional sill 301 is fixed on the car door sill and is located in door opening area. A length of the additional sill 301 is equal to a width of the door opening area, and a width of the additional sill 301 is slightly smaller than a gap between the car door sill 302 and the landing door sill 303. A brush 304 is fixed on a side of the additional sill near the landing door sill 303, and a length of the brush 304 is 3-5 mm to fill the gap between the additional sill 301 and the landing door sill 303.

When the elevator car reaches the landing floor, a movement of the car door drive motor 105 enables the transmission belt 106 to drive the fixing plate 109 to move, the car door hanging plate 102 that the fixing plate 109 located on thereby is driven to move. The connecting rob 1037 moves along the position-limit plate 1031, and the driving door knife 1034, along with the driven door knife 1033, clamps the door lock wheels 203. At the same time the movable hanger 206 is opened under a pull of the bar 208. At this time, the car door 104 and the landing door 204 are opened simultaneously, the additional sill 301 and the brush 304 between the car door sill 302 and the landing door sill 303 are exposed, so as to prevent the heels, wheels from being stuck and prevent some small items from falling.

When the elevator car is moving up and down, owing to the lateral installation of the driven door knife 1033, the driving door knife 1034 and the door lock wheels 203, which are located outside the door opening area, they will not interact with the additional sill 301. When the elevator car is moving up and down, the additional sill 301 and the brush 304 are moving within the door opening area, and the rub accidents is hard to occur for the enough gap and the dislocation between the door lock wheels 203 and the additional sill 301 and the brush 304.

The above embodiments are some preferred embodiments of this disclosure, but not intended to limit the protecting scope of the invention.

We claim:

1. An elevator door system with a laterally installed door knife, comprising:
a car door head, a door knife system fixed on the car door head, a landing door head, door lock wheels fixed on the landing door head, a car door, a landing door, a car door sill and a landing door sill;
wherein a fixing plate is disposed on a middle of the car door head, the door knife system is located on an end of the car door head, the door lock wheels are opposite to the door knife and an additional sill is fixed on the car door sill.

2. The elevator door system according to claim 1, wherein the door knife system comprises a driving door knife, a driven door knife, a connecting mechanism for connecting the driving door knife and the driven door knife, and a position-limit mechanism for controlling a movement of the driving door knife.

3. The elevator door system according to claim 1, wherein the fixing plate is fixed on a car door hanging plate on the car door head and is located in a middle of a door opening area, a top of the fixing plate is clamped on a transmission belt of a car door drive motor and the transmission belt drives the car door hanging plate to move.

4. The elevator door system according to claim 1, wherein the landing door head comprises a stationary hanger, a movable hanger and the door lock wheels; the movable hanger is connected to the door lock wheels through a bar.

5. The elevator door system according to claim 1, a brush is fixed on the additional sill.

6. The elevator door system according to claim 2, a brush is fixed on the additional sill.

7. The elevator door system according to claim 3, a brush is fixed on the additional sill.

8. The elevator door system according to claim 4, a brush is fixed on the additional sill.
